(19) United States
(12) Patent Application Publication
(10) Pub. No.: US 2012/0325393 A1
(43) Pub. Date: Dec. 27, 2012

(54) METHOD FOR PRODUCING A PARTICLE-BASED ELEMENT

(75) Inventor: Martin Denesi, Zvolen (CZ)

(73) Assignee: DASCANOVA GMBH, Linz (AT)

(21) Appl. No.: 13/520,509

(22) PCT Filed: Dec. 17, 2010
(86) PCT No.: PCT/EP2010/007752

§ 371 Date: Sep. 13, 2012

(30) Foreign Application Priority Data
Jan. 4, 2010 (DE) 10 2010 004 028.2

(51) Int. Cl. B27N 3/00

(52) U.S. Cl. 156/62.2

(57) ABSTRACT

The invention relates to a method for producing a particle-based element, especially a chipboard or fibreboard. A first three-dimensionally shaped structural element having first particles is produced. A second structural element having second particles is shaped so as to be complementary. The first structural element is connected to the second structural element.

The present invention relates to a method for producing a particle-based element, especially a chipboard or fibreboard.

A method for producing a particle-based element is known, for example, from international patent application WO 2009/017451 A1, in which a method for producing a wood-based furniture component is disclosed. For this purpose, wood chips are pressed in such a way that a plate-like component with projections results that is combined with another component in such a way that hollow spaces exist between the projections. It is consequently possible to achieve a reduced consumption of wood chips during the production and a lower weight of the component. The stability and the possible areas for a possible mounting of structural connections of the component are, however, reduced due to the hollow spaces.

DE 10 2004 024 878 A1 discloses a sandwich element that is formed from two covering layers and a middle layer arranged between them, whereby the middle layer can be formed in the shape of a periodically repeating, doubly curved shell structure. It is furthermore disclosed that the interspaces between the covering layer and the middle layer can be filled completely on one side or on both sides with a suitable material, for example, with a foamed material, in order to achieve an insulating effect. Such a production process proves to be difficult, however, because in addition to the production of the covering layers and the middle layer, a filling procedure must be provided for the interspaces.

The object of the present invention is to provide a method for producing a particle-based element whereby the method, on the one hand, can be operated economically and speedily and, on the other hand, allows the production of particle-based elements with customized structural properties.

This is achieved by means of a method with the following steps. First a first three-dimensionally shaped structural element having first particles is produced. A second structural element having second particles is shaped so as to be complementary and the first and second structural elements are connected. In this context, complementary shaping means that the surface structure of the first structural element forms a positive form that is in a custom fit with a surface structure of the second structural element and that consequently forms the corresponding (negative) counterpart. The complementary shaping of the second structural element and the connection of the first structural element to the second structural element can take place either one after the other or simultaneously. Due to the three-dimensionally shaped structure of the first structural element and the complementary shaping and connection to it of the second structural element, it is possible to achieve an integral element with improved structural properties. In particular, it is possible to achieve an increase in the structural stability and simultaneously a low weight of the particle-based element.

Advantageously, one of the structural elements is shaped in such a way that it has a greater stability than the other structural element, which in return has a lower density. The particle-based element has a plate-like shape particularly in the longitudinal and latitudinal directions.

Alternatively to the production of a particle-based element with a high level of stability at a low weight, the arrangement according to the invention also makes it possible to achieve a particle-based element with increased flexibility, in which areas of less stability and/or density are purposefully arranged within the particle-based element.

The first structural element and/or the second structural element is preferably produced by means of the application of heat and/or pressure to a particulate mass. Due to the heating or the pressure, the particles of the structural elements that form the particulate mass can be connected to one another. As a result of the pressure, it is furthermore possible to achieve a compaction of the particulate mass, by means of which a structural element can be produced whose density and strength are substantially determined by the pressure during production.

In one embodiment, the first structural element and/or the second structural element is produced by means of the insertion of a chemical agent into a particulate mass. The chemical agent can be an adhesive and/or a hardening agent that, by means of connecting the particles to one another, but also by means of the compaction of the individual particles, hardens the particulate mass into a structural element.

In particular, both the application of heat and/or pressure and the insertion of chemical agents can take place only locally in the first or second structural element, so that locally different compaction or stability of the structural element can be achieved. Areas with greater stability or lower density can therefore be produced purposefully.

In one embodiment, one of the structural elements has a greater density and/or stability than the other structural element. One structural element in the particle-based element consequently forms an area of greater stability or density, while the other structural element forms an area of lower density. In this way, it is possible to produce a particle-based element that achieves a high level of structural stability due to the structural element with greater density and/or greater stability, whereby the particle-based element nevertheless has only a low weight.

The complementary shaping of the second structural element and the connection of the structural elements can advantageously be carried out in one step. Due to the simultaneous execution of these steps, on the one hand, an operational step can be saved and, on the other hand, an optimal adjustment of the shaping of the complementary connection surfaces between the structural elements can be achieved.

In one embodiment, the second structural element is formed as a matrix for the first structural element. The first structural element is consequently held in a structure shaped by the second structural element. In particular, it should be emphasized that the first structural element does not necessarily have to be formed continuously, but instead can also be formed from a multiplicity of individual, locally arranged elements. The second structural element consequently forms a continuous structure in which the first structural element is arranged.

On the other hand, however, the second structural element can also be shaped within a matrix formed by the first structural element. The first structural element consequently now forms the continuous structure. The second structural element can, in turn, consist of a multiplicity of local, unconnected elements.

In one embodiment, one of the structural elements is formed in such a way that it extends from an upper side area to an under side area of the particle-based element. In this way, a high level of bending stability can be achieved, particularly for a plate-shaped particle-based element. By means of suitable extension in the height direction of the plate formed in the latitudinal and longitudinal direction, one of the structural elements can be formed spaced at a distance to the neutral zone or plane and continuously, so that the mechanical properties can be improved.

One of the structural elements is advantageously formed in such a way that it extends in a wavelike manner in a longitudinal direction of the particle-based element. The wave-shaped implementation of the structural element allows an increase in the structural stability of the particle-based element due to the reinforced areas arranged outside of the neutral zone. In addition, the wavelike shape offers advantages with regard to stability, because no angular zigzags are present that can have a negative effect on the stability of the structural element. The structural element that extends in a wavelike manner advantageously has greater stability than the other structural element. In addition, in this way the shearing strength of such an element is substantially increased.

It is advantageous for one of the structural elements to be formed in such a way that it extends in a wavelike manner also in a latitudinal direction of the particle-based element. In this way a particle-based element can be formed that has an increased bending strength both in the latitudinal direction and in the longitudinal direction.

In one embodiment, the first structural element is pre-shaped before being laid into the second particles, before the second structural element is shaped by means of a pressing procedure. By means of the shaping of the second particles in direct contact with the first structural element, it is possible to achieve both a stable connection between the structural elements and an optimal adjustment of the complementary, adjacent surfaces.

In one embodiment, the structural elements can be produced with a density in the area of their surfaces that differs from the density in the interiors of the structural elements. A compaction in the surface area of the structural elements shaped from particles can be achieved in a multiplicity of production methods, for example, by means of a pressing procedure, but also by means of suitable treatment of the upper side areas and under side areas of the particulate mass of the structural elements. If now one of the structural elements is shaped three-dimensionally, and the second structural element has a shape complementary to this, it is consequently possible to achieve areas distributed three-dimensionally in the particle-based element that have a different density, particularly a greater density. Areas of greater density or stability could consequently form a stabilizing structure and a particle-based element with a high density level with simultaneously low weight can be produced.

An area of increased stability is advantageously formed in such a way that it extends from an upper side area to an under side area of the particle-based element. The area of increased stability is, in particular, formed by the first or second structural element and allows an increase in the stability of the particle-based element, particularly if this has a plate-like form in the latitudinal direction and longitudinal direction and the area of increased stability extends in the height direction.

The area of increased stability is advantageously formed in such a way that it extends in a wave-like manner in a longitudinal direction of the particle-based element. This allows an increase in the bending strength particularly in the latitudinal direction of the particle-based element.

In one embodiment, the area of increased stability also extends in a wave-like manner in a latitudinal direction of the particle-based element. An increase of the stability can consequently be made possible both in the latitudinal direction and in the longitudinal direction of the particle-based element.

The particles of the particulate mass are preferably in a chip-form and/or fibre form. In particular, wood chips and/or natural fibres are used. The use of plastic chips is also possible, however. The particle-based element is, in particular, a fibreboard or a chipboard.

The particle-based element preferably has a plate-like shape.

The first particles and the second particles can be the same type of particle.

Different types of particles can also be used, however. The different types of particles can have different compression properties. The density and strength of the particle types can furthermore be different.

It is also possible to use particles with different ductility or hardness.

The first and second particles can have a different brittleness and different breaking behaviour. The first particles can furthermore have different abrasion properties than the second particles.

It is also possible purposefully to use a particle type that has greater elasticity than the other particle type.

The shape of the first particles can be different than the shape of the second particles.

It is furthermore possible to use particle types with different magnetic permeability or different electrical conductivity.

The thermal properties, melting behaviour and/or boiling behaviour can also differ between the first particles and the second particles.

It is furthermore possible to use particle types that have different photostability.

In one embodiment, the production of the particle-based element can take place in a flow method.

In another embodiment, however, it is also possible for the production of the particle-based element to take place in a stationary manner.

In the following, preferred embodiments of the connection device according to the invention are described on the basis of figures.

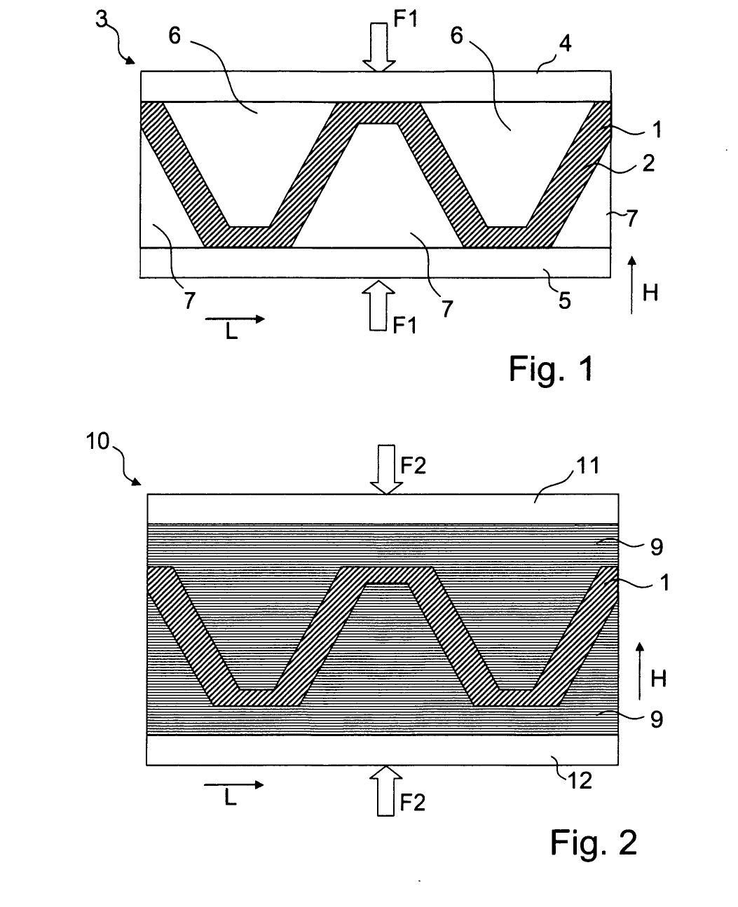

FIG. 1 shows a sectional view of the production of the first structural element in a first embodiment of the method according to the invention;

FIG. 2 shows a sectional view of the shaping of the second structural element in the first embodiment of the method according to the invention;

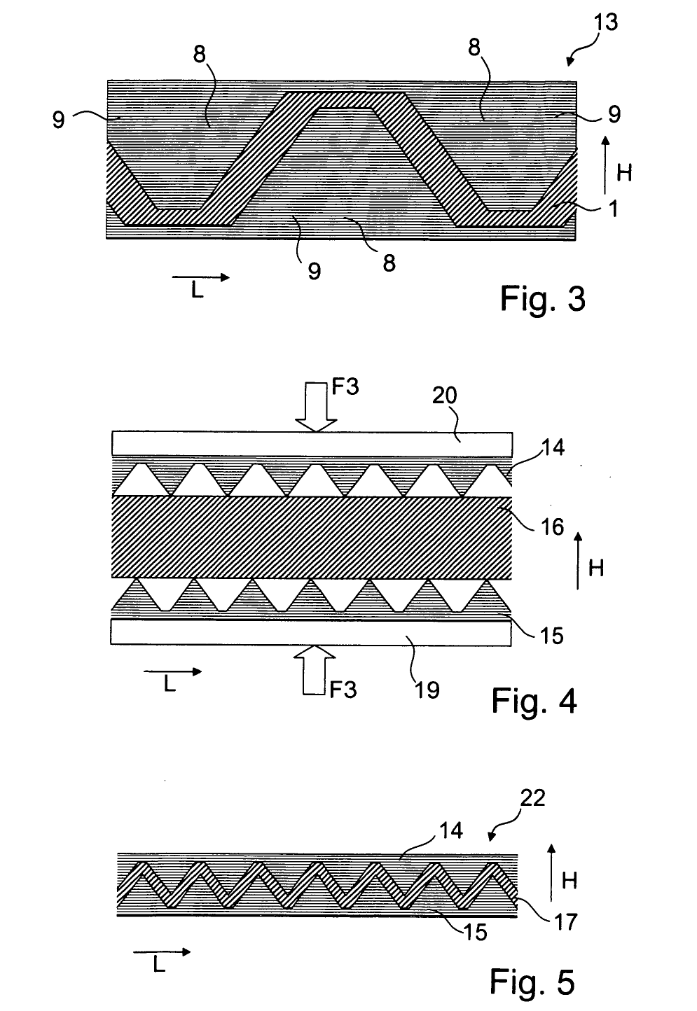

FIG. 3 shows a sectional view of a particle-based element that was produced with the first embodiment of the method according to the invention;

FIG. 4 shows a sectional view of the shaping of the second structural element according to a second embodiment of the method according to the invention;

FIG. 5 shows a sectional view of a particle-based element that was produced with the second embodiment of the method according to the invention;

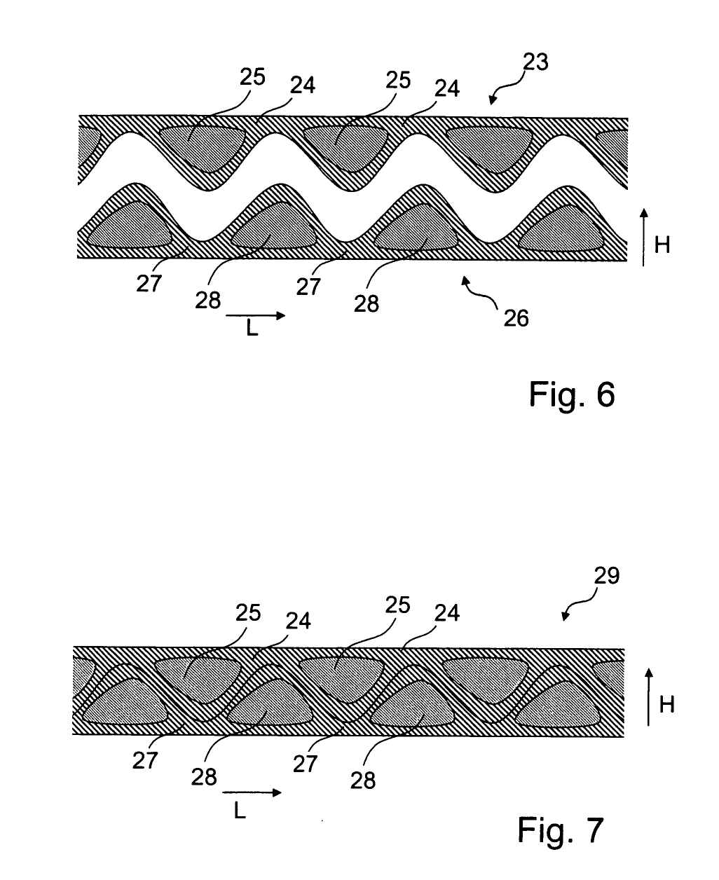

FIG. 6 shows a sectional view of the first and second structural elements in a third embodiment of the method according to the invention;

FIG. 7 shows a sectional view of a particle-based element that is produced with the third embodiment of the method according to the invention;

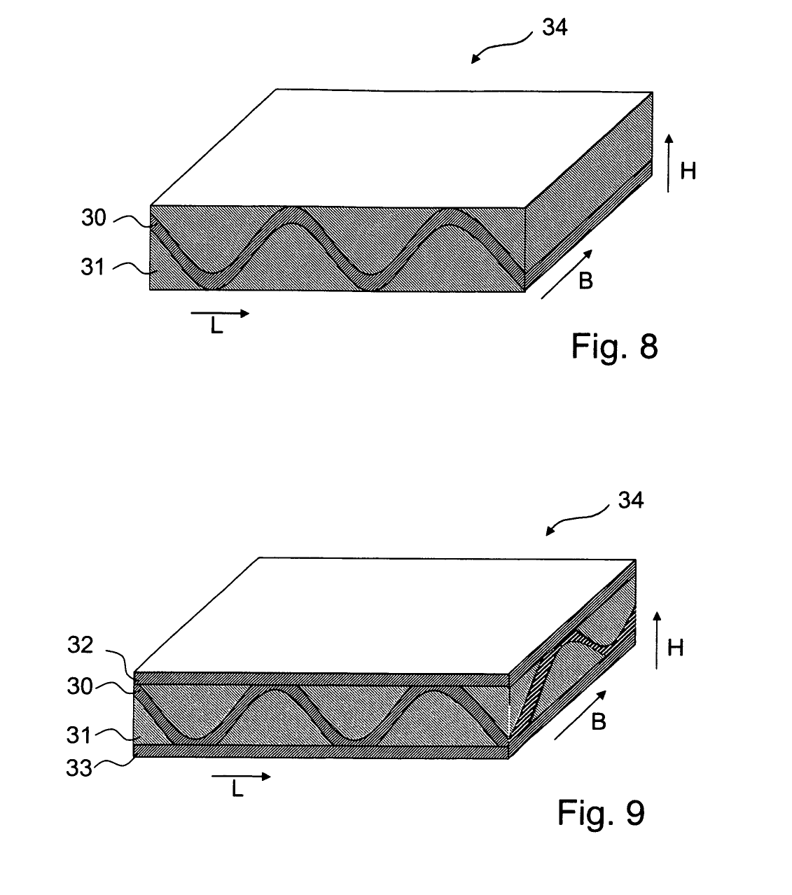

FIG. 8 shows a perspective sectional view of a particle-based element, in the shape of a plate, produced with an embodiment of the method according to the invention;

FIG. 9 shows a perspective sectional view of a further particle-based element produced with an embodiment of the method according to the invention.

FIGS. 1 to 3 depict a first embodiment of the method according to the invention.

FIG. 1 depicts the production of a three-dimensionally shaped first structural element 1 in a cross-sectional view. A particulate mass 2, consisting of first particles, is arranged in a first press 3. The first press 3 consists of an upper part 4 and a lower part 5, whereby the upper part 4 has upper projections 6 and the lower part 5 has lower projections 7. The upper projections 6 and the lower projections 7 are alternately arranged so that the particulate mass 2 is formed in between with essentially uniform density. The upper projections 6 project in a wedge shape downwards from the upper part 4 of the press 3. The lower projections 7 project in a wedge shape upwards from the lower part 5 of the press 3.

The projections 6, 7 can also alternatively be given a curved shape so that the particulate mass 2 is implemented in a harmonic wave shape.

The projections 6 and 7 are alternately arranged in the longitudinal direction L and extend perpendicularly to the drawing plane essentially linearly in the latitudinal direction.

A change in the height of the projections 6, 7 can also alternatively be provided in the latitudinal direction so that an essentially wave-shaped implementation of the first structural element 1 also results in this direction.

The upper part 4 and the lower part 5 of the press are stressed with a force F1 so that the first particulate mass 2 is compressed and compacted into a first structural element 1 in the height direction H. The first structural element 1 is thereupon removed from the first press 3.

FIG. 2 depicts the complementary shaping and connection of a second structural element 8 from a particulate mass 9.

The first structural element 1, together with a second particulate mass 9 consisting of second particles, is inserted into a second press 10.

The second press 10 consists of an upper part 11 and a lower part 12, the contact surface of each of which is formed in an essentially planar manner in the longitudinal direction L and latitudinal direction with the second particulate mass 9.

First a first part of the second particulate mass 9 is arranged on the lower part 12 of the press 10. Then the first structural element 1 is arranged on the first part of the second particulate mass 9 in such a manner that the second particulate mass 9 is continuously in contact with the under side of the first structural element 1.

A second part of the second particulate mass 9 is shaken on to the first structural element 1 and distributed in such a manner that the second part of the second particulate mass has an essentially planar upper surface in the longitudinal direction L and latitudinal direction.

Then the upper part 11 of the second press 10 is lowered on to the second particulate mass 9 and a force F2 is applied to the upper part 11 and lower part 12 of the second press 10 in the height direction H in order to compress the second particulate mass 9 into a second structural element 8.

The force F2 of the second press 10 is less than the force F1 of the first press 3, so that the second structural element 8 is compacted less than the first structural element 1.

FIG. 3 depicts a particle-based element 13 that was produced with the first embodiment of the method according to the invention. The second structural element 8 thereby surrounds the first structural element 1 both from above and from below. The first structural element 1 generally has a greater density and strength than the second structural element 8. The first structural element 1 consequently forms an area of greater stability in the particle-based element 13, while the second structural element 8 forms areas of lower density and consequently allows a particle-based element 13 with a low weight.

Alternatively to the implementation of the second structural element 9 depicted in FIG. 3, the second structural element 9 can also be arranged only in the recesses that were formed into the first structural element 1 by the projections 6 and 7, so that the first structural element 1 borders on the upper side and under side of the particle-based element 13.

An upper layer and a lower layer can furthermore additionally be connected to the particle-based element 13 so that the particle-based element 13 has a robust surface provided with a particular design as needed. This can be a polymer layer, for example, but also a veneer panel.

In a sectional view, FIG. 4 depicts a second embodiment of the method according to the invention. First a first particulate mass is shaped into the first structural elements 14, 15 by a pressing procedure. The first structural elements 14, 15 have a saw-tooth profile on one side and are planar on the other side. The first structural elements 14, are aligned to each other with the saw-tooth structure so that in the longitudinal direction L, in each case, the thickest sections in the height direction H of one of the first structural elements 14 are arranged in the area of the thinnest sections of the other first structural element 15.

A wave profile can also be provided on one side of the first structural elements as an alternative to the saw-tooth structure.

A second particulate mass 16 is arranged between the first structural elements. This preferably is brought about by first arranging the first structural element 15 on a lower part 19 of a press 20. Then the second particulate mass 19 is spread on to the first structural element 15, and then the first structural element 14 is arranged on the second particulate mass 16 in such a way that the saw-tooth structures of the first structural elements 14, 15 are arranged in alternation, as already described above.

An upper part 21 of the press 20 is then lowered on to the first structural element 14 and the two parts 19, 21 of the press 20 are acted upon by a force F3 so that the second particulate mass is pressed together into a second structural element 17 between the two first structural elements 14, 15.

The second structural element 17 has a greater strength than the first structural elements 14, 15, so that it forms an area of greater stability in the fully shaped, particle-based element 22. The first structural elements 14, 15 form areas of lower density.

The greater stability of the second structural element 17 can be achieved by means of the use of a suitable type of particle or a suitable bonding agent. It is also possible to select as the force F3 for the compaction of the second structural element 17 a force that is higher than the force for the compaction of the first structural elements 14, 15. The first structural elements 14, 15 have already hardened when they are pressed together with the second structural element 17, so that in the case of the first structural elements 14, 15, no substantial further compression takes place.

FIGS. 6 and 7 depict a third embodiment of the method according to the invention. First a first structural element 23 is shaped from a particulate mass, whereby an area 24 that is close to the surface has a greater density and stability than does an inner area 25. The first structural element 23 is formed so that it is essentially planar on one side and has wave-shaped elevations in the longitudinal direction L on the other side. The first structural element can be produced by means of the compression of a particulate mass, whereby the areas close to the surface can be more strongly compacted by the pressing procedure than the inner areas in the area of the greater thickness of the first structural element 23.

The areas close to the surface can, however, alternatively or additionally, also be provided with an adhesive or bonding agent, so that greater stability is achieved in this area.

A second structural element 26 with a planar surface on the one side and wave-shaped elevations on the other side that are complementary to the wave-shaped elevations of the first structural element 23 is produced correspondingly.

The second structural element 26 likewise has areas 27 close to the surface with greater stability and inner areas 28 with lower density.

The first structural element 23 and the second structural element are, as shown in a sectional view in FIG. 7, connected on their complementary wave-shaped surfaces into a particle-based element 29. The particle-based element 29 has an essentially planar upper side and under side. An area of greater stability extends in a wave-like shape in the longitudinal direction L in the interior of the particle-based element 29. The particle-based element furthermore has areas of increased stability in the area of the upper side and under side. The remaining areas of the particle-based element 29 are formed by the inner areas 25 of the first and second structural elements 23, 26 that form areas of lower density.

The connection of the first and the second particle-based elements is implemented by means of the application of a bonding agent or adhesive on to the wave-shaped surfaces of the first and second structural elements 23, 26 and by subsequent pressing.

It is consequently possible with this method to produce a particle-based element 29 that has a high level of stability while simultaneously having a low weight.

FIG. 8 depicts a particle-based element 34 produced with a method according to the invention in a perspective sectional view in the longitudinal direction L and latitudinal direction B. The particle-based element 34 has an area of increased stability 30 and an area of reduced density 31. The area of increased stability 30 extends in a wave shape in the longitudinal direction L from an under side to an upper side of the particle-based element. The area of increased stability 30 is embedded in the area of reduced density 31. Due to the fact that the area of increased stability 30 extends from an under side area to an upper side area of the particle-based element 34, and runs continuously in this, an increase in the structural stability of the particle-based element 34 is caused. The bending strength of the particle-based element 34 is increased due to the fact that the area of increased stability, due to its wave-shaped extension, connects areas outside of the neutral fibres, or planes, of the plate-shaped particle-based element 34. The bending strength of the particle-based element 34 is thereby increased particularly in the latitudinal direction B.

The area of increased stability 30 can either be formed in accordance with FIG. 3 by the first structural element 1 or in accordance with FIG. 5 by the second structural element 17 or in accordance with FIG. 7 each time by an area of the first and second structural elements 23, 26.

FIG. 9 depicts a further particle-based element 34 with an area of increased stability 30 and an area of reduced density 31 in a perspective sectional view in the longitudinal direction L and latitudinal direction B. In this particle-based element 34, the area of increased stability 30 extends in a wavelike manner both in the longitudinal direction L and in the latitudinal direction B. In turn, the area of increased stability 30 extends from an under side area to an upper side area of the particle-based element 34.

In the upper side area, the particle-based element 34 has an upper layer of increased stability 32 that forms a surface of the particle-based element 34. In the under side area, the particle-based element has a lower layer of increased stability 33 that forms an under side of the particle-based element.

The wave-shaped area of increased stability 30 can merge into the upper layer 32 and the lower layer 33 seamlessly. The remaining area of the particle-based element 34 forms an area of reduced density 31.

The upper layer 32 and the lower layer 33 can likewise be formed by one of the structural elements or an area of the structural elements. Alternatively, additional particles can also be arranged in this area before the pressing procedure, whereby these particles cause the increased stability of the upper layer 32 and the lower layer 33. An upper layer and lower layer can additionally or alternatively be applied as a separate component before or after the pressing. It is consequently possible by means of the method according to the invention to produce a particle-based element 34 in accordance with FIG. 9 that has increased structural stability and a high level of stability in the area of the upper and under sides with a relatively low weight.

Each of the figures depicts only a detail of the particle-based element, which is usually longer and wider.

Various bonding agents are possible for adhering the particles, particularly the wood chips, that are used as particles in a multiplicity of applications. A frequently used bonding agent is urea-formaldehyde resin (UF resin). It is alternatively possible to use phenol-formaldehyde resins that additionally offer the advantage of being water resistant. A multiplicity of mixed resins that contain phenol and/or melamine can furthermore be used as bonding agents. The chips can also be connected by means of isocyanate.

The individual chips can furthermore be connected with adhesives. Use of natural adhesives is possible, for example, lignin, tannin, carbohydrates, bone glue, blood glue or protein glues. In general, however, other adhesives, such as epoxy resin, for example, can also be used.

The first particles of the first particulate mass and the second particles of the second particulate mass can be different particle types with the differences briefly discussed in the following.

For example, during the arrangement of the particulate mass, it is already possible to provide a different density in the first and second particles, as a result of which the weight and stability properties of the particle-based element can be substantially influenced.

It is furthermore possible to provide particles with different levels of hardness in order to increase the hardness of the particle-based element locally.

The particles of the first particulate mass and of the second particulate mass can furthermore be connected with a different bonding agent or with a different quantity of the bonding agent in order to increase the stability locally or the stability of a structural element as a whole.

It is, however, also possible to provide particles having different brittleness and consequently different breaking behaviour so that, for example, the brittleness of the structurally supporting part of the particle-based element is purposefully reduced while lower grade particles can be used for the other areas of the particle-based element.

The elasticity of the particle-based element can in this way be influenced purposefully, in that the first or the second particulate mass has an elasticity that differs from that of the other particulate mass. In this way, both the elasticity of the particle-based element per se and also the local resilience of the particle-based element can be adapted for different intended uses.

There can furthermore be structural differences, such as, for example, in the particle size of the first particles and the second particles.

Other properties of the particulate mass can also be influenced suitably for a multiplicity of applications. For example, the magnetic permeability of a part of the particulate mass can be purposefully changed, for example, in order to allow shielding against electromagnetic radiation.

The thermal properties of parts of the particulate mass can furthermore be influenced in order also to allow the use of the particle-based element in areas of elevated or low temperatures. Further differences between the first and second particulate mass can lie in the viscosity, the melting behaviour and the boiling behaviour.

For certain applications, a use of a first and second particulate mass with different electrical conductivity can also be of interest. In other applications, in turn, a different photostability level can be provided in the first and second particulate masses.

1. A method for producing a particle-based element, the method comprising:
producing a first three-dimensionally shaped structural element having first particles;
complementarily shaping a second structural element having second particles; and
connecting the first structural element to the second structural element;
wherein each structural element is produced with a density and/or stability in an area of its surface that differ/differs from a density and/or stability in an interior of the structural element, and wherein the first structural element and the second structural element are connected to each other in such a way that an area of changed density or stability is formed within the particle-based element by their surfaces.

2. The method according to claim 1 wherein the first structural element and/or the second structural element are/is produced by applying heat and/or pressure to a particulate mass.

3. The method according to claim 1 wherein the first structural element and/or the second structural element are/is produced by means of introducing a chemical agent into a particulate mass.

4. The method according to claim 1 wherein one of the structural elements has a greater density and/or stability than does the other structural element.

5. The method according to claim 1 wherein the shaping of the second structural element and the connecting of the structural elements are executed in one step.

6. The method according to claim 1 wherein the shaping of the second structural element is performed such that the second structural element is shaped as a matrix for the first structural element.

7. The method according to claim 1 wherein the shaping of the second structural element is performed such that the second structural element is shaped within a matrix formed by the first structural element.

8. The method according to claim 1 wherein one of the structural elements is formed in such a way that it extends from an upper side area to an under side area of the particle-based element.

9. The method according to claim 1 wherein one of the structural elements is formed in such a way that it extends in a wavelike manner in a longitudinal direction of the particle-based element.

10. The method according to claim 9 wherein the one structural element is formed in such a way that it extends in a wavelike manner also in a latitudinal direction of the particle-based element.

11. The method according to claim 1 further comprising inserting the first structural element into the second particles, wherein the shaping of the second structural element is performed by a pressing procedure, and wherein the first structural element is pre-shaped before being inserted into the second particles, and before the second structural element is shaped by the pressing procedure.

12. (canceled)

13. (canceled)

14. The method according to claim 1 wherein the method is performed such that an area of increased stability is formed in such a way that it extends from an upper side area to an under side area of the particle-based element.

15. The method according to claim 14 wherein the area of increased stability is formed in such a way that it extends in a wavelike manner in a longitudinal directions of the particle-based element.

16. The method according to claim 15 wherein the area of increased stability is formed in such a way that it extends in a wavelike manner also in a latitudinal direction of the particle-based element.

17. The method according to claim 1 wherein the first structural element is produced by applying heat and/or pressure to a particulate mass and introducing a chemical agent into the particulate mass.

18. The method according to claim 1 wherein the first and second structural elements are each produced by applying heat and/or pressure to a particulate mass and introducing a chemical agent into the particulate mass.

19. A method for producing a particle-based element, the method comprising:
producing a first three-dimensionally shaped structural element having first particles;
producing a second structural element having second particles and a shape that is complimentary to the first structural element; and
connecting the first structural element to the second structural element;
wherein each structural element is produced such that the structural element has an interior, a surface and an area proximate the surface that has a greater density and/or stability compared to a density and/or stability in the interior of the structural element, and wherein the first structural element and the second structural element are connected to each other in such a way that the areas of the structural elements cooperate to form an area within the particle-based element.
